(19) United States
(12) Patent Application Publication
(10) Pub. No.: US 2025/0335725 A1
(43) Pub. Date: Oct. 30, 2025

(54) SYSTEM AND METHOD FOR MULTILINGUAL SPEECH-TO-SPEECH TRANSLATION WITH SPEECH REFINEMENT USING COMBINED MACHINE LEARNING MODELS

(71) Applicant: Sanas.ai Inc., Palo Alto, CA (US)

(72) Inventors: Jason Lin, Los Altos, CA (US); Schwinn Saereesitthipitak, Stanford, CA (US); Scott Hickmann, Stanford, CA (US)

(21) Appl. No.: 18/651,312

(22) Filed: Apr. 30, 2024

(51) Int. Cl. G06F 40/58

(52) U.S. Cl. CPC G06F 40/58

(57) ABSTRACT

Methods and systems are provided for multilingual idiomatic translation using large language model. In one novel aspect, customized prompt is generated for a selected large language model (LLM) to generate an idiomatic translation. In one embodiment, the input for the idiomatic translation is multilingual, which contains mixed multiple languages. In one embodiment, the computer system generates a customized prompt for a selected LLM, wherein the customized prompt concatenates a system instruction, an output language indication, and an input content, wherein the customized prompt is dynamically generated for an idiomatic translation of the text input. In one embodiment, the system instruction contains one or more elements comprising a direct instruction for multilingual detection for the input, a direct instruction for output text format, and an indication customized for translation. In another embodiment, the computer system performs an LLM selection procedure using an LLM selection prompt.

### TECHNICAL FIELD

The present invention relates generally to language translation and speech recognition technology, in particular to multilingual speech-to-speech translation with speech refinement.

### BACKGROUND

Multilingual translation using Artificial Intelligence (AI), or Large Language Models (LLMs) represents a critical frontier in the field of machine learning. While traditional translation solutions have made significant strides in bridging language barriers, they encounter considerable challenges when faced with speech containing multiple languages mixed together.

Existing speech-to-text translation models typically rely on speech-to-text transcription models designed to handle one input language at a time. This limitation significantly hampers their effectiveness in scenarios where multiple languages are spoken concurrently and struggle with handling speech that contains multiple languages mixed together.

Moreover, most existing solutions focus on literal translations, lacking the capability to refine the translations to make them more fluent or professional. Additionally, these solutions often provide literal translations that lack the finesse required for fluent or professional communication.

Improvements and enhancement are needed for an AI/LLM-based multilingual translation.

### SUMMARY

Methods and systems are provided for multilingual idiomatic translation using large language model. In one novel aspect, customized prompt is generated for a selected LLM to generate an idiomatic translation. In one embodiment, the input for the idiomatic translation is multilingual, which contains a mixed a multiple language. In one embodiment, the computer system obtains a text input, wherein the text input is associated with one or more languages, generates a customized prompt for a selected large language model (LLM), wherein the customized prompt concatenates a system instruction, an output language indication, and an input content, wherein the customized prompt is dynamically generated for an idiomatic translation of the text input, passes the customized prompt in the selected LLM to generate a translation output, wherein the translation output is an idiomatic translation, and presents the translation output. In one embodiment, the system instruction contains one or more elements comprising a direct instruction for multilingual detection for the input, a direct instruction for output text format, and a translation indication customized for translation. In one embodiment, the translation indication further indicates a polished translation. In another embodiment, the system instruction is “Find all the languages present in this code, and return it as a JSON array of ISO 639-1 codes. Do not say anything else, directly give the response. Here is the text.” In one embodiment, the computer system further processes a voice speech by one or more users into the text input, and wherein the voice speech is transcribed into the text input by a selected speech-to-text model. In one embodiment, the translation output is presented as a text output, a speech output or a combination of text and speech output. In another embodiment, the computer system performs an LLM selection procedure to select an LLM among a group of candidate LLMs as the selected LLM. In one embodiment, the LLM selection procedure uses an LLM selection prompt instructing each candidate LLM to perform the idiomatic translation. In another embodiment, the LLM selection procedure uses a predefined set of text input texts. In yet another embodiment, the computer system obtains reference input, wherein the text input is generated based on the reference input. In one embodiment, the reference input is a file name.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates exemplary diagrams for a multilingual idiomatic translation computer system with speech refinement using combined machined learning model in accordance with embodiments of the current invention.

FIG. 2 illustrates exemplary diagrams of the prompt generator with system instruction for idiomatic multilingual translation in accordance with embodiments of the current invention.

FIG. 3 illustrates exemplary diagrams selecting a LLM for the idiomatic multilingual translation using customized prompt in accordance with embodiments of the current invention.

FIG. 4 illustrates an exemplary block diagram of a machine in the form of a computer system performing multilingual idiomatic translation with speech refinement using combined machined learning model in accordance with embodiments of the current invention.

FIG. 5 illustrates an exemplary flow chart for multilingual idiomatic translation with speech refinement using combined machined learning model in accordance with embodiments of the current invention.

### DETAILED DESCRIPTIONS

Reference will now be made in detail to some embodiments of the invention, examples of which are illustrated in the accompanying drawings.

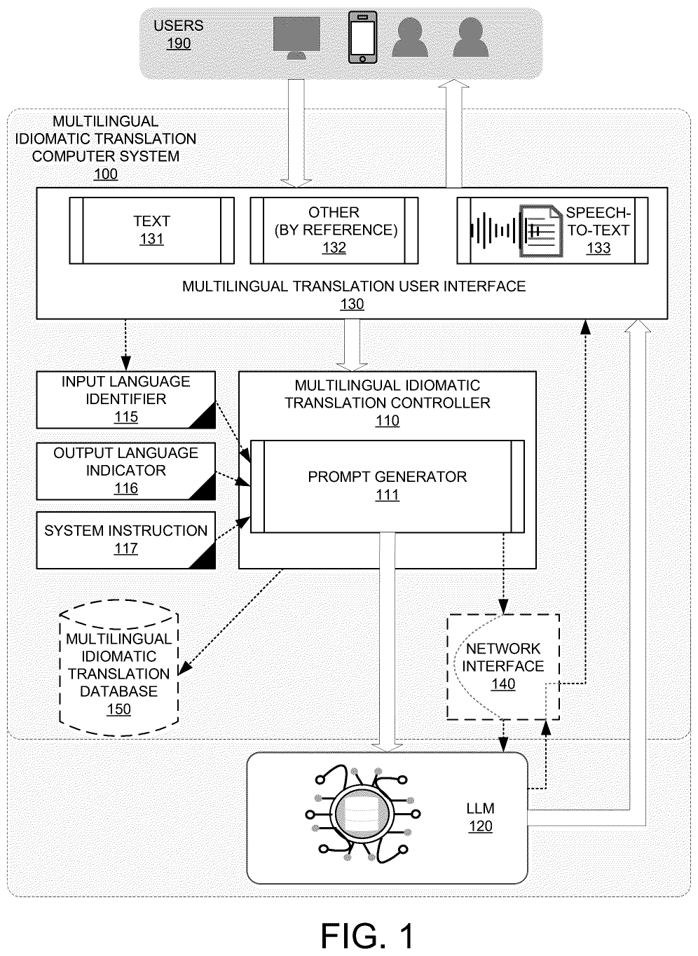

FIG. 1 illustrates exemplary diagrams for a multilingual idiomatic translation computer system with speech refinement using combined machined learning model in accordance with embodiments of the current invention. The multilingual idiomatic translation takes a mixed language input and output the idiomatic translation. An exemplary multilingual idiomatic translation computer system 100 includes a multilingual idiomatic controller 110, optionally, an LLM module 120, a user interface 130, a network interface 140 and a multilingual idiomatic translation database 150. In one embodiment, LLM 120 is integrated with the multilingual idiomatic translation computer system 100. In another embodiment, LLM 120 is connected with the multilingual idiomatic translation computer system 100 through network interface 140. One or more users 190 interact with multilingual idiomatic translation computer system 100 through the user interface 130. Users 190 can be users interacting with multilingual idiomatic translation computer system 100 through text input, speech input, or combination of speech and text input, or input by reference. Users 190 interacts with user interface 130 through multiple devices, such as a computer system or mobile devices. From the user interface, the user can choose to either speak or type text as input. In one embodiment 131, the user input is a text input. In another embodiment 133, the user input is a voice speech. The speak-to-text model will transcribe what the user is saying and fill the input text with the transcribed text. In yet other embodiments 132, the input can be in other forms for multilingual idiomatic translation computer system 100 to obtain the input text/contents. In one embodiment, the input received from the user interface 130 is a reference, such as file name or a reference point. The user interface 130 recognizes the reference input and obtains contents, such as documents and/or files, based on the input reference.

In one embodiment, prompt generator 111 of multilingual idiomatic controller 110 concatenates a system instruction 117, an output language indication 116, and the input content from the user interface 130 and generates a customized prompt for LLM 120. In one embodiment, LLM 120 is an integral part multilingual idiomatic computer system 100. The generated customized prompt is directly passed to LLM 120. In another embodiment, the generated customized prompt passed to LLM 120 through network interface 140. In one embodiment, prompt generator 111 obtains input language identifier 115 to generate the customized prompt. In one embodiment, the input language indicator 115 is obtained through the user interface 130 via direct user input. In another embodiment, the input language indicator 115 is labelled/processed through the speech-to-text module and/or the text input module, which identifies the language. In one embodiment, the speech-to-text module uses OpenAI Whisper, which processes multiple languages in the same text. The generated customized prompt is passed to a selected LLM, such as LLM 120. LLM 120 outputs the translated text based on the customized prompt, which enables idiomatic multilingual translation. In one embodiment, the selected LLM 120 is GPT-4 Turbo. In one embodiment, the output from LLM 120 is passed to the user interface 130 to present to user 190. The output can be presented in one more format including text output, speech output, the combination of text and speech output or other forms, such as a reference link to an output file/document. In one embodiment, the output format is set based on a user input received through the user interface 130.

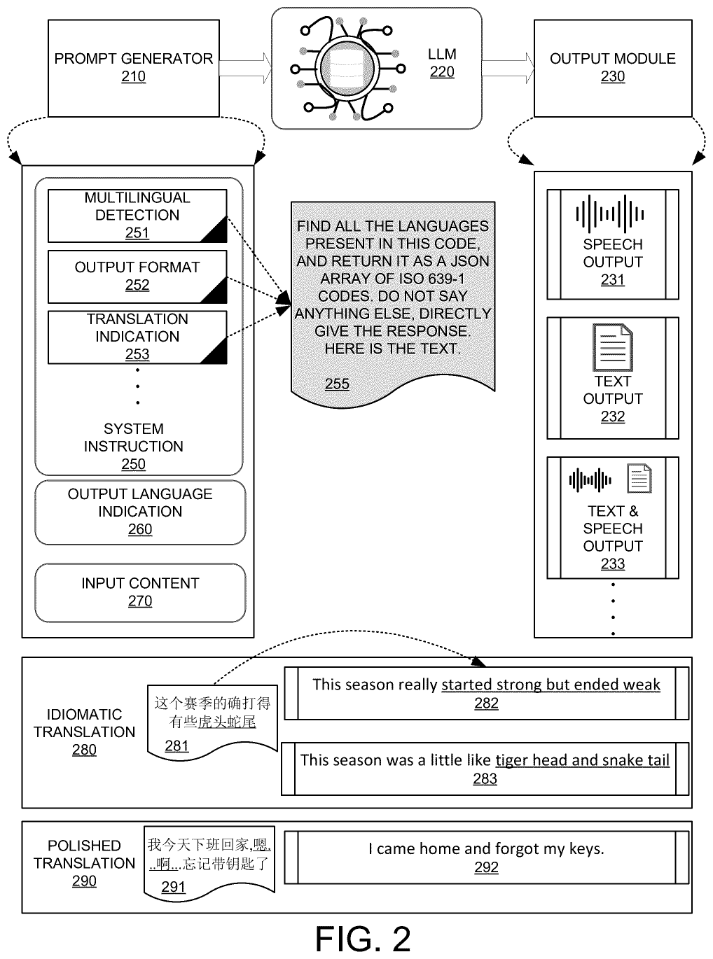

FIG. 2 illustrates exemplary diagrams of the prompt generator with system instruction for idiomatic multilingual translation in accordance with embodiments of the current invention. In one novel aspect, customized prompt is generated for the selected LLM such that the translation output is an idiomatic and polished translation instead of a word-by-word translation. An idiomatic translation 280 is a translation using, containing, or denoting expressions that are natural to a native speaker of the destination language. For example, an idiomatic translation for a Chinese phrase 281 “ [symbol] [symbol] [symbol] ” is “This season really started strong but ended weak” 282, where the idiomatic translation for the phrase “ [symbol] ” is “started strong but ended weak,” which uses the expression that is natural to a native English speaker. Without the improved idiomatic translation, the AI translation would output 283 “This season was a little like tiger head and snake tail,” wherein the expression of “a little like tiger head and snake tail” is a word-to-word translation which does not match the expression in the Chinese language and makes no meaningful expression in English. A polished translation 290 rephrases the user's translation into a neutral tone that is appropriate and concise. For example, a polished translation of “ [symbol] [symbol] , [symbol] . . . [symbol] . . . [symbol] ” 291 is “I came home and forgot my keys” 292, where the fillers of “ [symbol] . . . [symbol] . . . ” are omitted to give polished translation with the concise and appropriate output. AI/LLM produces different outputs with different prompts due to the nature of their training and the mechanisms involved in generating text. The development of the LLM model itself relies on the customized prompt to produce more desired outputs, such as idiomatic translation and/or translation for multilingual inputs.

A selected LLM 220 receives customized prompt from prompt generator 210 and sends the output to the output module 230. In one novel aspect, a multilingual input content is obtained from one or more users through a user interface. The input content is not directly put through LLM 220. The input content is processed by prompt generator 220. In one embodiment, the prompt generator 210 concatenates a system instruction 250, an output language indication 260, and an input content 270 to generate the customize prompt for LLM 220. In one embodiment, system instruction 250 instructs LLM 220 to detect multilingual contents and instructs LLM 220 with specific output format for the purpose of translation. In one embodiment, system instruction 250 includes one or more elements comprising multilingual instruction 251, output format 252, and translation indication 253. In one embodiment, translation indication 253 indicates an idiomatic translation. In another embodiment, translation indication 253 further indicates a polished translation. In one embodiment 255, system instruction 250 is “Find all the languages present in this code, and return it as a JSON array of ISO 639-1 codes. Do not say anything else, directly give the response. Here is the text.” Upon receiving the customized prompt generated by prompt generator 220, with the system instruction concatenating with the user input content, LLM 220 output idiomatic and/or polished translation for the user input contents. Output module 230 presents the translation as speech output 231, or text output 232, or combination of text and speech output 233, or other formats, such as a reference to the translation output.

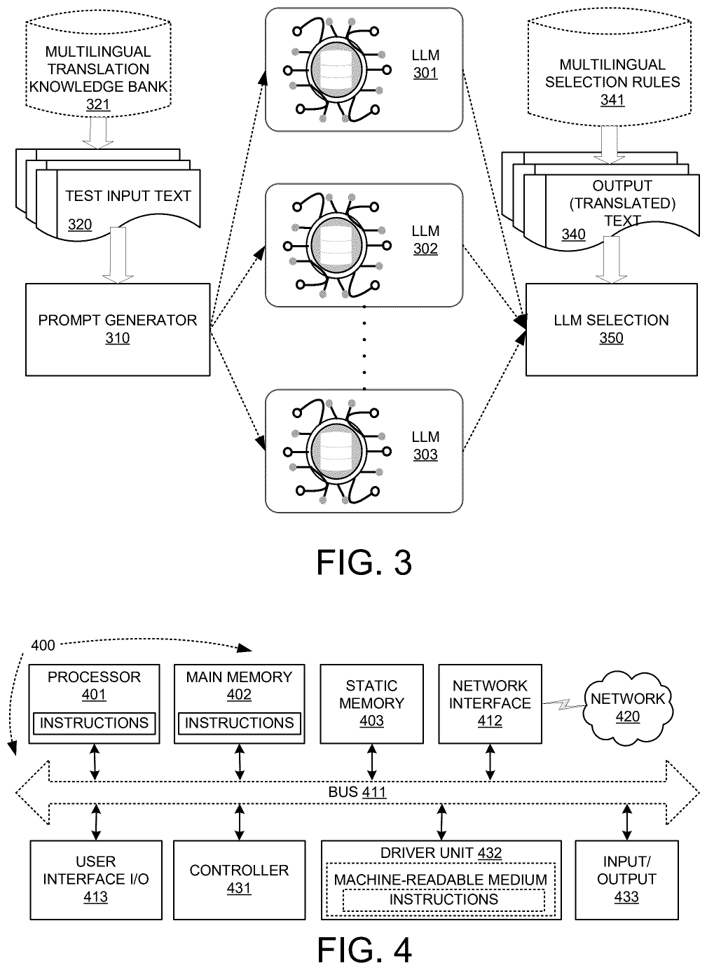

FIG. 3 illustrates exemplary diagrams selecting a LLM for the idiomatic multilingual translation using customized prompt in accordance with embodiments of the current invention. In one novel aspect, an LLM or a combination of LLMs are selected to perform the multilingual idiomatic translation.

FIG. 4 illustrates an exemplary block diagram of a machine in the form of a computer system performing multilingual idiomatic translation with speech refinement in accordance with embodiments of the current invention. The landscape of LLM/AI models is diverse, with various architectures, sizes, and capabilities tailored to different tasks and domains. Therefore, selecting a suitable/optimized LLM is an important aspect. In the traditional way, selecting the model involves assessing the model architecture, size, pre-training data, and fine-tuning opportunities to ensure alignment with task requirements. Understanding the complexity and specificity of the task, along with resource constraints and performance metrics, aids in identifying models that offer optimal performance within the given constraints. In one novel aspect, a controlled testing/evaluation of LLM is provided using customized prompt to select the LLM. In one embodiment, a prompt generator 310 is used to generate customized prompt for a preselected set of test input text 320. In one embodiment, test input text 320 is generated based on multilingual translation knowledge bank 321. For example, a set of text content with idiomatic expressions for a specific language is selected. In one embodiment, the selection can be dynamically updated. The same generated prompt is passed to a plurality of candidate LLMs, such as LLM 301, LLM 302, and LLM 303. The outputs from the candidate LLMs are analyzed by LLM selection module 360. In one embodiment, LLM selection 350 analyzes the outputs based on output (translated) text 340, which corresponds to the set of test input text 320. In one embodiment, LLM selection module 360 selects the LLM based on one or more predefined multilingual selection rules 341.

FIG. 4 illustrates an exemplary block diagram of a machine in the form of a computer system performing multilingual idiomatic translation with speech refinement using combined machined learning model in accordance with embodiments of the current invention. In one embodiment, apparatus/device 400 has a set of instructions causing the device to perform any one or more methods for speech emotion recognition used for interview questions. In another embodiment, the device operates as a standalone device or may be connected through a network to other devices. Apparatus 400 in the form of a computer system includes one or more processors 401, a main memory 402, a static memory unit 403, which communicates with other components through a bus 411. Network interface 412 connects apparatus 400 to network 420. Apparatus 400 further includes user interfaces and I/O component 413, controller 431, driver unit 432, and input/output unit 433. Driver unit 432 includes a machine-readable medium on which stored one or more sets of instructions and data structures, such as software embodying or utilize by one or more methods for the speech emotion recognition function. The software may also reside entirely or partially within the main memory 402, the one or more processor 401 during execution. In one embodiment, the one or more processor 401 is configured obtain a text input, wherein the text input is associated with one or more languages, generate a customized prompt for a selected large language model (LLM), wherein the customized prompt concatenates a system instruction, an output language indication, and an input content, wherein the customized prompt is dynamically generated for an idiomatic translation of the text input, pass the customized prompt in the selected LLM to generate a translation output, wherein the translation output is an idiomatic translation, and present the translation output. In one embodiment, software components running one or more processors 401 run on different network-connected devices and communicate with each other via predefined network messages. In another embodiment, the functions can be implemented in software, firmware, hardware, or any combinations.

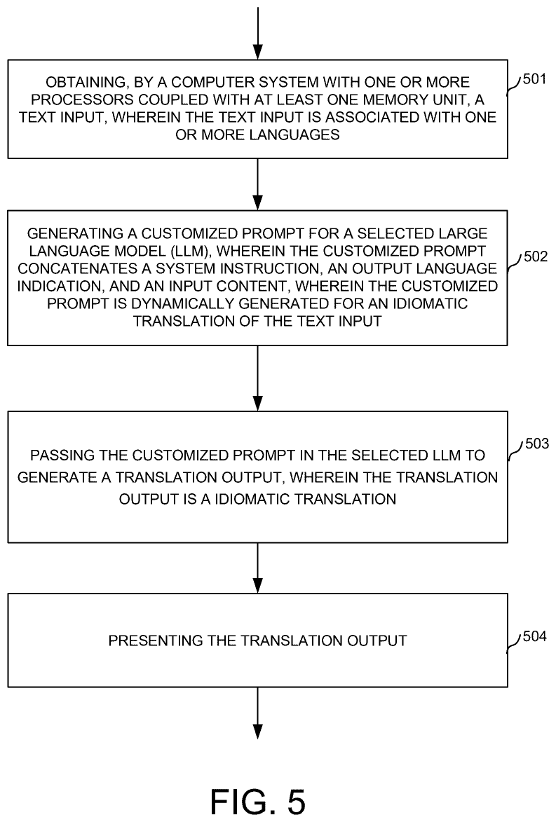

FIG. 5 illustrates an exemplary flow chart for multilingual translation with speech refinement using combined machined learning model in accordance with embodiments of the current invention. At step 501, the computer system obtains a text input, wherein the text input is associated with one or more languages. At step 502, the computer system generates a customized prompt for a selected large language model (LLM), wherein the customized prompt concatenates a system instruction, an output language indication, and an input content, wherein the customized prompt is dynamically generated for an idiomatic translation of the text input. At step 503, the computer system passes the customized prompt in the selected LLM to generate a translation output, wherein the translation output is an idiomatic translation. At step 504, the computer system presents the translation output.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed:

1. A method, comprising:
obtaining, by a computer system with one or more processors coupled with at least one memory unit, a text input, wherein the text input is associated with one or more languages;
generating a customized prompt for a selected large language model (LLM), wherein the customized prompt concatenates a system instruction, an output language indication, and an input content, wherein the customized prompt is dynamically generated for an idiomatic translation of the text input;
passing the customized prompt in the selected LLM to generate a translation output, wherein the translation output is an idiomatic translation; and
presenting the translation output.

2. The method of claim 1, wherein the system instruction contains one or more elements comprising a direct instruction for multilingual detection for the input, a direct instruction for output text format, and a translation indication customized for the idiomatic translation.

3. The method of claim 2, wherein the translation indication is further customized to indicate a polished translation.

4. The method of claim 3, wherein the system instruction is “Find all the languages present in this code, and return it as a JSON array of ISO 639-1 codes. Do not say anything else, directly give the response. Here is the text.”

5. The method of claim 1, further comprising: processing a voice speech by one or more users into the text input, and wherein the voice speech is transcribed into the text input by a selected speech-to-text model.

6. The method of claim 1, wherein the translation output is presented as a text output, a speech output or a combination of text and speech output.

7. The method of claim 1, further comprising performing an LLM selection procedure to select an LLM among a group of candidate LLMs as the selected LLM.

8. The method of claim 7, wherein the LLM selection procedure uses an LLM selection prompt instructing each candidate LLM to perform the idiomatic translation.

9. The method of claim 7, wherein the LLM selection procedure uses a predefined set of text input texts.

10. The method of claim 1, further comprising: obtaining a reference input, wherein the text input is generated based on the reference input.

11. The method of claim 10, wherein the reference input is a file name.

12. An apparatus comprising:
a network interface that connects the apparatus to a communication network;
a user interface that obtains one or more user inputs from one or more users and presents an output result to the one or more users;
a memory; and
one or more processors coupled to one or more memory units, the one or more processors configured to
obtain a text input, wherein the text input is associated with one or more languages;
generate a customized prompt for a selected large language model (LLM), wherein the customized prompt concatenates a system instruction, an output language indication, and an input content, wherein the customized prompt is dynamically generated for an idiomatic translation of the text input;
pass the customized prompt in the selected LLM to generate a translation output, wherein the translation output is an idiomatic translation; and
present the translation output.

13. The apparatus of claim 12, wherein the system instruction contains one or more elements comprising a direct instruction for multilingual detection for the input, a direct instruction for output text format, and a translation indication customized for the polished translation.

14. The apparatus of claim 13, wherein the translation indication is further customized to indicate a polished translation.

15. The apparatus of claim 14, wherein the system instruction is “Find all the languages present in this code, and return it as a JSON array of ISO 639-1 codes. Do not say anything else, directly give the response. Here is the text.”

16. The apparatus of claim 12, wherein the one or more processors are further configured to process a voice speech by one or more users into the text input, and wherein the voice speech is transcribed into the text input by a selected speech-to-text model.

17. The apparatus of claim 12, wherein the translation output is presented as a text output, a speech output or a combination of text and speech output.

18. The apparatus of claim 12, further comprising performing an LLM selection procedure to select an LLM among a group of candidate LLMs as the selected LLM.

19. The apparatus of claim 18, wherein the LLM selection procedure uses an LLM selection prompt instructing each candidate LLM to perform the idiomatic translation and a predefined set of text input texts.

20. The apparatus of claim 12, further comprising: obtaining a reference input, wherein the text input is generated based on the reference input, and wherein the reference input is a file name.
